(19) United States
(12) Patent Application Publication
(10) Pub. No.: US 2019/0322155 A1
(43) Pub. Date: Oct. 24, 2019

(54) HEATER MODULE FOR HEATING COOLING WATER

(71) Applicant: Hanon Systems, Daejeon (KR)

(72) Inventors: In Hyeok KIM, Daejeon (KR); Jung Jae LEE, Daejeon (KR); Jae Yeong JU, Daejeon (KR); Young Chul KIM, Daejeon (KR); Hak Kyu KIM, Daejeon (KR); Hyuk KIM, Daejeon (KR); Jong Du LEE, Daejeon (KR)

(21) Appl. No.: 16/389,138

(22) Filed: Apr. 19, 2019

(30) Foreign Application Priority Data
Apr. 20, 2018 (KR) 10-2018-0046114
Oct. 26, 2018 (KR) 10-2018-0128762
Apr. 16, 2019 (KR) 10-2019-0044431

(51) Int. Cl. B60H 1/14; B60H 1/00

(52) U.S. Cl. CPC B60H 1/143; B60H 1/00278; B60H 2001/2228; B60H 1/00485; B60H 1/00885; B60H 1/00385

(57) ABSTRACT

The heater module includes a fluid pump including a pump inlet configured to introduce cooling water thereinto, a pump outlet configured to pressurize and discharge the introduced cooling water, cooling water heating heater including a heater inlet configured to introduce thereinto the cooling water discharged from the pump outlet of the fluid pump, a heating unit configured to heat the introduced cooling water, a heater outlet configured to discharge the heated cooling water, a flow channel switch valve for switching a circulation flow channel of the cooling water, wherein the fluid pump is integrally formed with one side of the cooling water heating heater to embody both a heating mode and a battery temperature-rising mode by one heater module for heating cooling water. Thus, a connection hose for connection components is removed or a length thereof is minimized, a fluid pump and a valve housing are reduced, thereby reducing costs.

### CROSS-REFERENCE TO RELATED APPLICATIONS

This application claims priority under 35 U.S.C. § 119 to Korean Patent Application Nos. 10-2018-0046114 filed on Apr. 20, 2018, 10-2018-0128762 filed on Oct. 26, 2018, and 10-2019-0044431 filed on Apr. 16, 2019, which is hereby incorporated herein by reference in its entirety.

### TECHNICAL FIELD

The following disclosure relates to a heater module for heating cooling water, and more particularly, to a heater module for heating cooling water configured by integrally modularizing cooling water heating heater, a pump, and a valve.

### BACKGROUND

In general, various air conditioning systems, cooling systems, and the like are installed in a vehicle. The air conditioning system includes heating and cooling modules for adjusting air temperature, humidity, and the like of an indoor compartment in which a vehicle passenger is present, and the cooling system includes modules for cooling devices such as an engine or a motor to prevent the cooling devices from overheating. The various modules are configured to perform a desired operation such as air conditioning, heating, or cooling by transferring heat while circulating a heat exchange medium such as a refrigerant, cooling water, or a coolant.

A hybrid vehicle using both an engine and an electric motor or an electric vehicle using only an electric motor uses a motor that generates a much smaller amount of heat than an engine and, thus, there has been a need for a new type of heating structure such as a method of heating cooling water using a heat pump system or a heater to heat air via a heater core instead of a conventional heating method.

For example, Japanese Patent Laid-Open Publication No. 2012-239344 (“Air Heating Apparatus of Electro Motion Vehicle”, Dec. 6, 2012) discloses technology for selectively performing a temperature-rising operation of a battery and a heating operation of a vehicle indoor compartment by switching a flow channel as necessary using a system including a plurality of heaters and configured to variously switch a flow channel for a heat exchange medium. As shown in FIG. 1A, in the case of a heating mode, cooling water is pumped by cooling water pump 1 and is, then, heated while passing through cooling water heater 2, the high-temperature cooling water flows to a heater core 3 to transfer heat to air in a vehicle indoor compartment via heat exchange, and the cooling water that becomes at a low temperature via heat exchange is circulated in such a way that the cooling water is re-introduced into the cooling water pump 1. When an external temperature is low, as shown in FIG. 1B, a battery temperature-rising mode in which a temperature of a battery 4 rises for a smooth operation of the battery 4 may be executed and, in this case, cooling water discharged from the heater core 3 is introduced into the battery 4 through a bypass valve 5 to increase the temperature of the battery 4 to an appropriate temperature for a smooth operation. The cooling water that passes through the battery 4 and is discharged from the battery 4 returns to the cooling water pump 1 through a three way valve 6, and the returning cooling water performs cooling water is circulated in such a way that the cooling water is re-introduced to the cooling water heater 2 by the cooling water pump 1.

As shown in FIG. 1, in order to selectively drive the heating mode and the battery temperature-rising mode, various components such as the cooling water pump 1, the cooling water heater 2, the bypass valve 5, and a hose and clamp for connecting the components need to be installed in a vehicle, and there is a need to overcome a problem in terms of design for disposing the components in a limited space and a problem in terms of an increase in the number of assembly processes due to an increase in the number of components.

### SUMMARY

An embodiment of the present disclosure is directed to providing a heater module for heating cooling water, in which cooling water heating heater, a pump for pressurizing a circulated cooling water, and a valve for switching a flow channel are integrally modularized to embody both a heating mode and a battery temperature-rising mode by one heater module for heating cooling water and, thus, a connection hose for connection components may be removed or a length thereof may be minimized, and a fluid pump and a valve housing may be reduced, thereby reducing costs and reducing the number of assembly processes.

The present disclosure is not limited to the above objects, and additional objects of the present disclosure will be set forth in part in the description which follows and in part will become apparent to those having ordinary skill in the art upon examination of the following or may be learned from practice of the present disclosure.

In one general aspect, a heater module for heating cooling water includes a fluid pump including a pump inlet configured to introduce cooling water thereinto and a pump outlet configured to pressurize and discharge the introduced cooling water, and cooling water heating heater including a heater inlet configured to introduce thereinto the cooling water discharged from the pump outlet of the fluid pump, a heating unit configured to heat the introduced cooling water, and a heater outlet configured to discharge the heated cooling water, wherein the fluid pump is integrally formed with one side of the cooling water heating heater.

The fluid pump may be disposed to be inclined to one side at a geometric center of the cooling water heating heater, and the heater inlet of the cooling water heating heater may be formed close to the fluid pump disposed to be inclined to the one side, and the heater outlet of the cooling water heating heater may be formed far from the fluid pump disposed to be inclined to the one side.

The fluid pump may be disposed to be spaced apart from an external surface of the cooling water heating heater by a predetermined interval.

The pump outlet of the fluid pump may be disposed perpendicular to a direction in which the cooling water of the pump inlet is introduced, and an outlet of the pump outlet may be disposed toward the heater inlet.

The cooling water heating heater may include a heating body for heating the cooling water, and cooling water heating flow channel for guiding a flow of the cooling water, and the cooling water heating flow channel may be formed to be disposed in parallel to a direction of an opening of the pump outlet.

The heating body of the cooling water heating heater may be a planar heating body, and the cooling water heating flow channel may be formed in a zigzag form above the planar heating body.

The heater module may further include a pump heater connection hole configured to connect a pump outlet and a heater inlet to each other.

The pump heater connection hole may be formed of a flexible material.

The pump outlet may be disposed downward in a direction toward the cooling water heating heater, the heater inlet may be formed to face an end of the pump outlet, and the pump outlet and the heater inlet may be directly coupled to each other.

The heater module may further include a flow channel switch valve for switching a flow channel of the cooling water, wherein the flow channel switch valve may be positioned at one side of the fluid pump and is integrally formed with the cooling water heating heater.

The flow channel switch valve includes a plurality of openings, and one of the plurality of openings is formed to be integrally coupled to the pump inlet of the fluid pump.

The flow channel switch valve and the fluid pump may be integrally formed and are disposed to be inclined to one side of the cooling water heating heater, and the heater inlet of the cooling water heating heater may be formed closer to the fluid pump than the flow channel switch valve.

The heater module may further include a bracket for integrally coupling the fluid pump and the fluid channel switch valve to the cooling water heating heater.

The bracket may include a fluid pump fix bracket for coupling the fluid pump, and a flow channel switch valve fix bracket for coupling the flow channel switch valve.

The fluid pump fix bracket may be coupled to a pump operation unit of the fluid pump, and the flow channel switch valve fix bracket may be coupled to a valve operation unit of the flow channel switch valve.

A fluid pump fix vibration absorber configured to absorb vibration during an operation of the fluid pump may be inserted between the fluid pump fix bracket and the fluid pump, and a flow channel switch valve fix vibration absorber configured to absorb vibration during an operation of the flow channel switch valve may be inserted between the flow channel switch valve fix bracket and the flow channel switch valve.

A plurality of bracket couplers with the fluid pump fix bracket and the flow channel switch valve fix bracket coupled thereto may be formed above the cooling water heating heater, and the bracket coupler may protrude upward to dispose the fluid pump and the flow channel switch valve to be spaced apart from an upper surface of the cooling water heating heater.

Through holes with coupling bolts inserted thereinto may be formed in opposite sides of each of the fluid pump fix bracket and the flow channel switch valve fix bracket, and the coupling bolts may penetrate the through holes of each of the fluid pump fix bracket and the flow channel switch valve fix bracket to couple the fluid pump and the flow channel switch valve to the cooling water heating heater.

The fluid pump fix bracket and the flow channel switch valve fix bracket may be configured in the form of handcuffs with separated upper and lower portions, the upper and lower portions having one rotatable side, and the fluid pump or the flow channel switch valve may be accommodated between the upper and lower portions.

A plurality of bracket couplers with the fluid pump fix bracket and the flow channel switch valve fix bracket coupled thereto may protrude in a lateral direction on a side surface of the cooling water heating heater, and the fluid pump fix bracket and the flow channel switch valve fix bracket may be coupled to an upper surface of the bracket coupler.

The fluid pump fix bracket and the flow channel switch valve fix bracket may each be separated into an upper bracket and a lower bracket, and the lower bracket may be formed to be spaced from a side surface and an upper surface of the cooling water heating heater by a predetermined interval.

The bracket may further include a base bracket coupled to the cooling water heating heater, and the fluid pump fix bracket and the flow channel switch valve fix bracket may be formed to be coupled to the base bracket.

The bracket may include a base bracket coupled to cooling water heating heater, a fluid pump fix bracket for coupling a fluid pump, and a flow channel switch valve fix bracket for coupling a flow channel switch valve.

The fluid pump fix bracket may be coupled to a pump operation unit of a fluid pump, and the flow channel switch valve fix bracket may be coupled to a valve operation unit of a flow channel switch valve.

A fluid pump fix vibration absorber configured to absorb vibration during an operation of a fluid pump may be inserted between the fluid pump fix bracket and the fluid pump, and a flow channel switch valve fix vibration absorber configured to absorb vibration during an operation of a flow channel switch valve may be inserted between the flow channel switch valve fix bracket and the flow channel switch valve.

The cooling water heating heater may be formed in a cylindrical shape and includes a cylindrical heating body for heating the cooling water therein.

The cooling water heating heater may include cooling water heating flow channel disposed with a helical shape, and the heater inlet of the cooling water heating heater may be formed in an outer circumferential surface of the cooling water heating heater.

The cooling water heating heater may include cooling water heating flow channel disposed in a helical shape, the heater inlet of the cooling water heating heater may be formed in an outer circumferential surface of the cooling water heating heater, the pump outlet of the fluid pump may be disposed downward in a direction toward the cooling water heating heater, and the heater inlet may be directly coupled to and face an end of the pump outlet.

The heater module for heating cooling water may be mounted and used in a vehicle.

In this case, the heater module may be mounted to be inclined to lower a side of the fluid pump by a predetermined angle based on a horizontal surface.

### BRIEF DESCRIPTION OF THE DRAWINGS

FIG. 1 is a diagram for explanation of a flow of cooling water in a heating mode and a battery temperature-rising mode through a conventional vehicle heating system.

FIG. 2 is a perspective view of a heater module for heating cooling water according to an embodiment of the present disclosure.

FIG. 3 is a diagram showing a flow of cooling water of a heater module for heating cooling water in a third direction according to an embodiment of the present disclosure.

FIG. 4 is a diagram showing a flow of cooling water of a heater module for heating cooling water in a second direction according to an embodiment of the present disclosure.

FIGS. 5 and 6 are diagrams for explanation of arrangement of a heater module for heating cooling water according to an embodiment of the present disclosure.

FIG. 7 shows a first modification example of a heater module for heating cooling water according to an embodiment of the present disclosure.

FIG. 8 is a diagram for explanation of an arrangement of a heater module for heating cooling water according to another embodiment of the present disclosure.

FIG. 9 is a diagram showing a first modification example of a heater module for heating cooling water according to another embodiment of the present disclosure.

FIG. 10 shows a second modification example of a heater module for heating cooling water according to another embodiment of the present disclosure.

FIG. 11 is a diagram showing the case in which a fluid pump and a flow channel switch valve are integrally formed according to an embodiment of the present disclosure.

FIG. 12 is a perspective view of a bracket according to an embodiment of the present disclosure.

FIGS. 13 and 14 show an example in which a heater module for heating cooling water is coupled to a vehicle according to an embodiment of the present disclosure.

FIG. 15 is a perspective view of a heater module for heating cooling water according to another embodiment of the present disclosure.

FIG. 16 is an exploded perspective view of a heater module for heating cooling water according to another embodiment of the present disclosure.

FIG. 17 is a front view of a heater module for heating cooling water according to another embodiment of the present disclosure.

FIG. 18 is a perspective view of a fix bracket according to another embodiment of the present disclosure.

FIGS. 19 and 20 are a perspective view and an exploded perspective view of a heater module for heating cooling water according to another embodiment of the present disclosure, respectively.

FIG. 21 is a front view of a heater module for heating cooling water according to another embodiment of the present disclosure.

FIG. 22 is an exploded perspective view of a fix bracket according to another embodiment of the present disclosure.

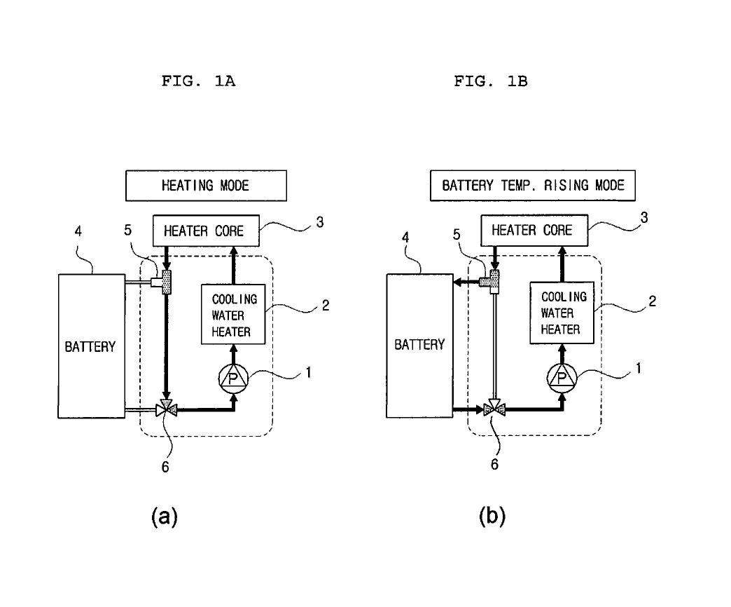

### DETAILED DESCRIPTION OF EMBODIMENTS

Hereinafter, a heater module for heating cooling water with above configuration according to the present disclosure will be described in detail with reference to the accompanying drawings.

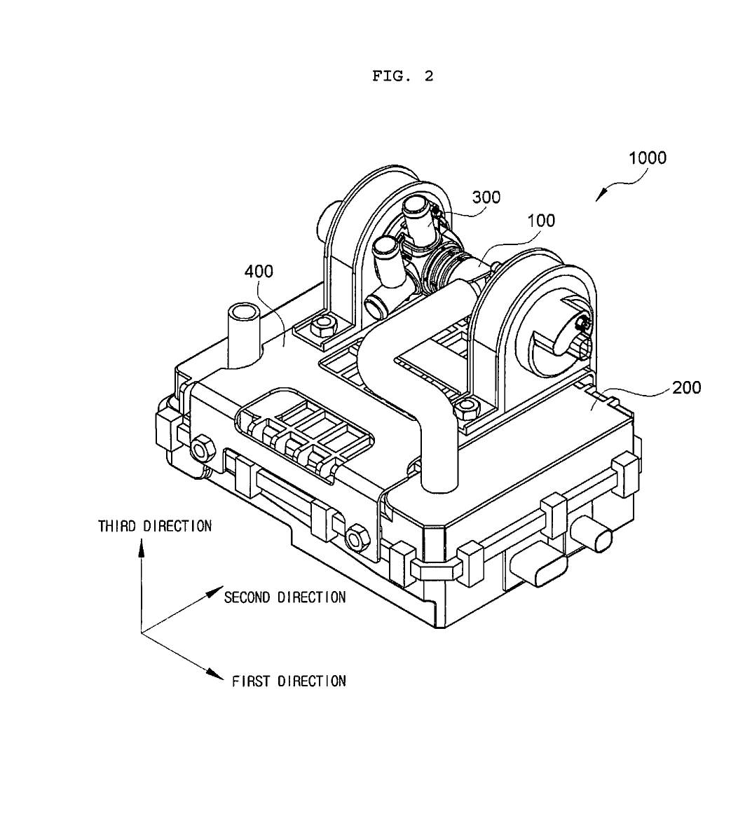

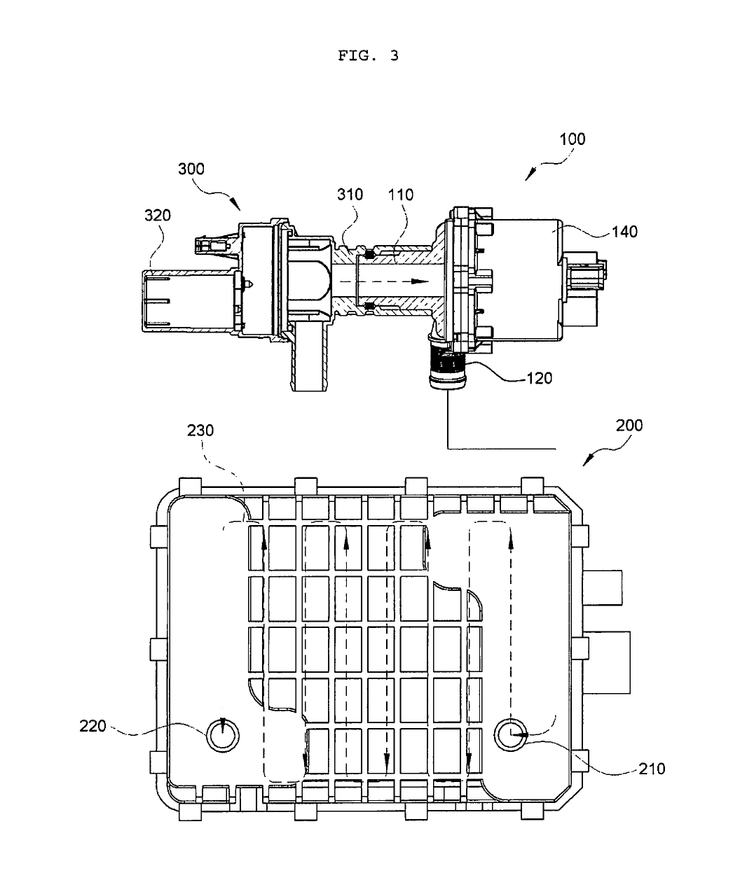

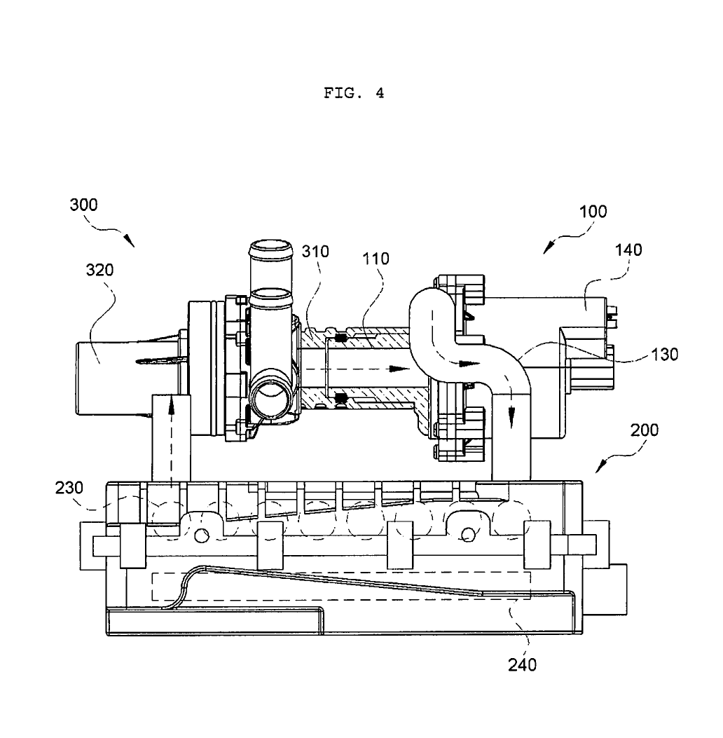

FIG. 2 is a perspective view of a heater module for heating cooling water according to an embodiment of the present disclosure. FIGS. 3 and 4 are diagrams for explanation of cooling water flow of a heater module for heating cooling water according to the present disclosure.

Referring to FIGS. 2 to 4, the heater module for heating cooling water according to the present disclosure may be configured via integral modularization of a fluid pump 100, cooling water heating heater 200, and a flow channel switch valve. The fluid pump 100 according to the present disclosure may be a device for applying a pressure in order to circulate cooling water and may include a pump inlet 110 into which cooling water is introduced and which is formed at one side of the fluid pump 100, a pump outlet 120 which is formed at the other side of the fluid pump 100 in order to discharge the introduced cooling water, and a pump operation unit 140 for driving a pump. In this case, the pump outlet 120 may be open in a direction perpendicular to the pump inlet 110.

The cooling water heating heater 200 according to the present disclosure may be a device for heating and supplying cooling water and may include a heater inlet 210 into which cooling water discharged from the pump outlet 120 of the fluid pump 100 is introduced, a heating unit for heating the introduced cooling water, a heater outlet 220 for discharging the heated cooling water, cooling water heating flow channel 230 for guiding a flow of the cooling water, and a heating body 240 for heating the cooling water.

A flow channel switch valve 300 according to the present disclosure may be a device for switching a flow channel for selectively driving a heating mode and a battery temperature-rising mode and may include a plurality of openings for forming a plurality of flow channels, and a valve operation unit 320 for switching a flow channel. According to an embodiment of the present disclosure, an opening for discharging cooling water through a pump among the plurality of openings may be referred to as a valve outlet 310. Although FIG. 2 illustrates the case in which the flow channel switch valve 300 is integrally formed with the fluid pump 100 and the cooling water heating heater 200, and the flow channel switch valve 300 may be separately formed and disposed as necessary.

With reference to FIGS. 3 and 4, a flow of cooling water of the heater module for heating cooling water according to the present disclosure will now be described. When cooling water is discharged through the fluid pump 100 via an operation of the flow channel switch valve 300, the cooling water may be pressurized by the fluid pump 100 and may be supplied to the cooling water heating heater 200. In this case, the fluid pump 100 may rotate an impeller (not shown) of the pump operation unit 140 to pressurize the introduced cooling water and, thus, the pump outlet 120 may be disposed perpendicular to the pump inlet 110 and, accordingly, the heater inlet 210 of the cooling water heating heater 200 may be disposed adjacent to the pump outlet 120 and may be inclined to one side of the cooling water heating heater 200. The cooling water introduced through the heater inlet 210 may flow along the cooling water heating flow channel 230 and, in this case, the cooling water may be heated through the heating body 240 and, then, may be discharged to the outside through the heater outlet 220. In this case, the cooling water heating flow channel may be disposed in parallel to a direction in which the cooling water of the pump outlet 120 is discharged and, thus, interruption of a flow of the pressurized cooling water may be prevented. The cooling water heating heater 200 according to an embodiment may include the heating body 240 with a planar shape, and the cooling water heating flow channel 230 may be formed in a zigzag form above the heating body 240 with a planar shape.

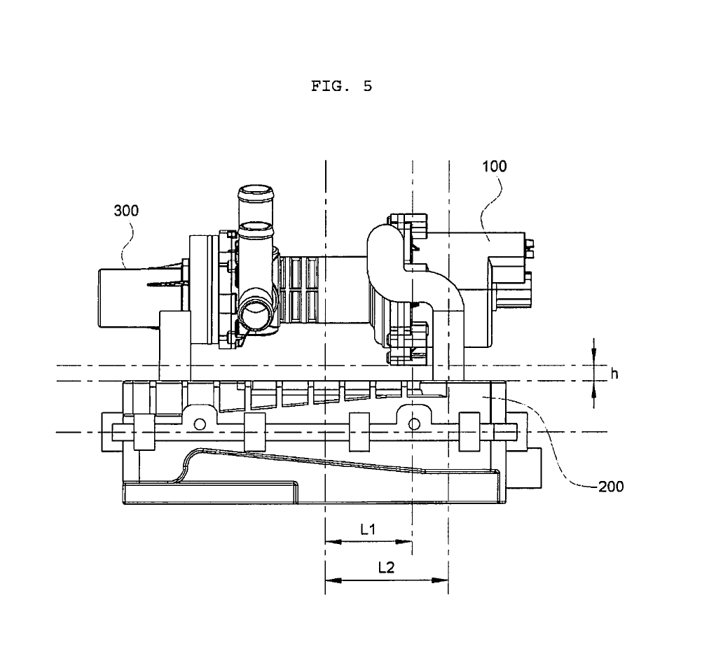

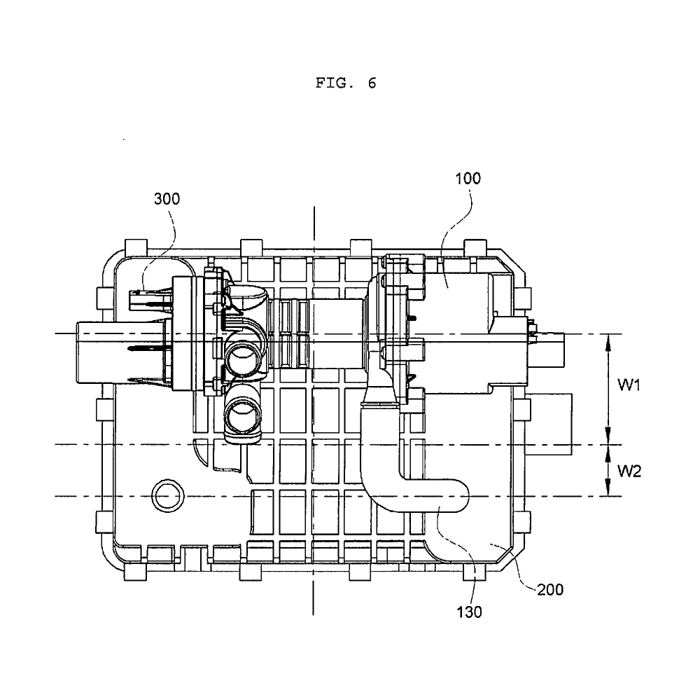

FIGS. 5 and 6 are diagrams for explanation of arrangement of a heater module for heating cooling water according to an embodiment of the present disclosure. The fluid pump 100 according to the present disclosure may be disposed to be inclined at a geometric center of the cooling water heating heater 200.

FIG. 5 illustrates the case in which the fluid pump 100 is disposed to be inclined in a first direction in which cooling water is introduced to the fluid pump 100. For example, a heater inlet of the cooling water heating heater 200 may be spaced apart from the geometric center of the cooling water heating heater 200 by a predetermined distance L2, and a pump outlet of the fluid pump 100 may also be spaced apart from the geometric center of the cooling water heating heater 200 by another predetermined distance L1 and, in this case, L1 may be smaller than L2. The fluid pump 100 may be spaced apart from an external surface of the cooling water heating heater 200 by a predetermined interval h, thereby preventing an overheating malfunction of the fluid pump 100 due to heat of the cooling water heating heater 200.

FIG. 6 illustrates the case in which the fluid pump 100 is disposed to be inclined in a second direction in which cooling water is discharged from the fluid pump 100. For example, the center of a fluid inlet of the fluid pump 100 may be spaced apart from the geometric center of the cooling water heating heater 200 by a predetermined distance W1, a heater inlet of the cooling water heating heater 200 may be spaced apart from the geometric center of the cooling water heating heater 200 in an opposite direction by another predetermined distance W2 and, thus, the cooling water discharged from the fluid pump 100 may be introduced into the cooling water heating heater 200 to prevent interruption of a flow of the cooling water. In this case, the pump outlet 120 of the fluid pump 100 and the heater inlet 210 of the cooling water heating heater 200 may be connected to each other through a pump heater connection hole. A pump heater connection hole 130 may be formed of a flexible material, thereby preventing vibration of the pump operation unit 140 from being transferred to the cooling water heating heater 200.

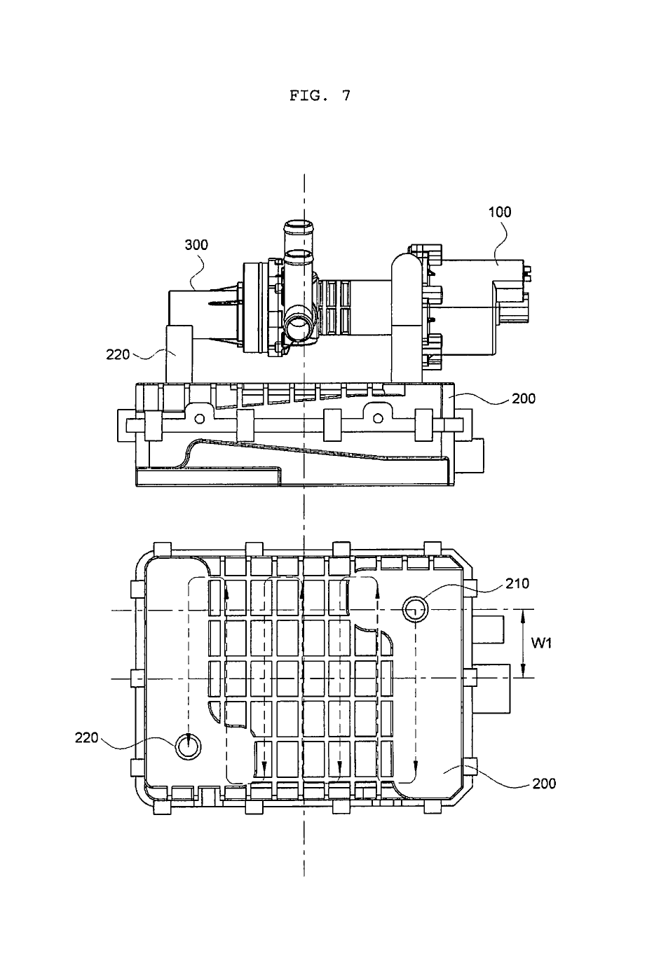

FIG. 7 shows a modification example of a heater module for heating cooling water according to an embodiment of the present disclosure and, here, the pump outlet 120 of the fluid pump 100 and a heater inlet of the cooling water heating heater 200 are directly connected to each other without a separate connection hole. In this case, both the center of a fluid inlet of the fluid pump 100 and a heater inlet of the cooling water heating heater 200 may be spaced apart from the geometric center of the cooling water heating heater 200 by a predetermined distance W1, and an outlet of the fluid pump 100 may be disposed downward in a third direction that is orthogonal to the first direction and the second direction. In this case, a separate connection hole is not required, and thus, the number of components may be reduced, and a module may be configured to be more compact.

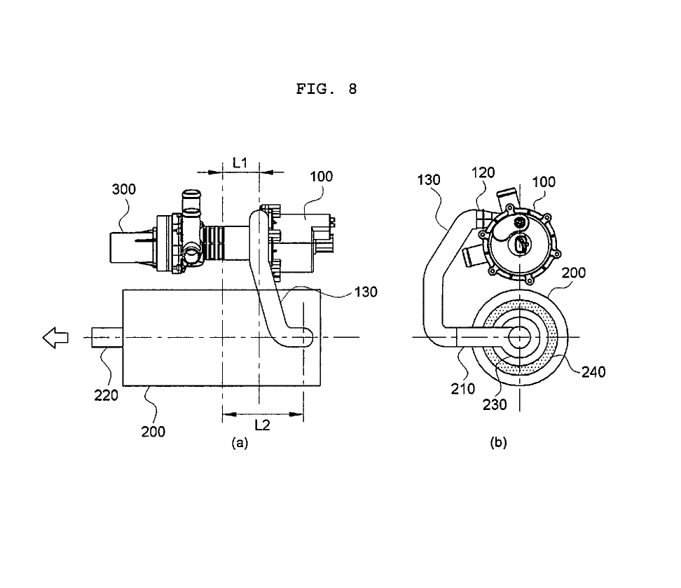

FIGS. 8 to 10 are diagrams for explanation of a heater module for heating cooling water according to another embodiment of the present disclosure. According to another embodiment of the present disclosure, the cooling water heating heater 200 may be formed in a cylindrical shape, and the heating body 240 may also be formed with a cylindrical shape in the cooling water heating heater 200. According to another embodiment, the fluid pump 100 may also be spaced apart from the geometric center of the cooling water heating heater 200 by the predetermined distance L1 and may be spaced apart from an outer circumferential surface of the cooling water heating heater 200 by the predetermined interval h.

According to the embodiment of FIG. 8, the heater inlet 210 of the cooling water heating heater 200 may be formed on a plane at one side of the cooling water heating heater 200 with a cylindrical shape and, here, cooling water discharged from the pump outlet 120 of the fluid pump 100 may be introduced to the heater inlet 210 of the cooling water heating heater 200 through the pump heater connection hole 130.

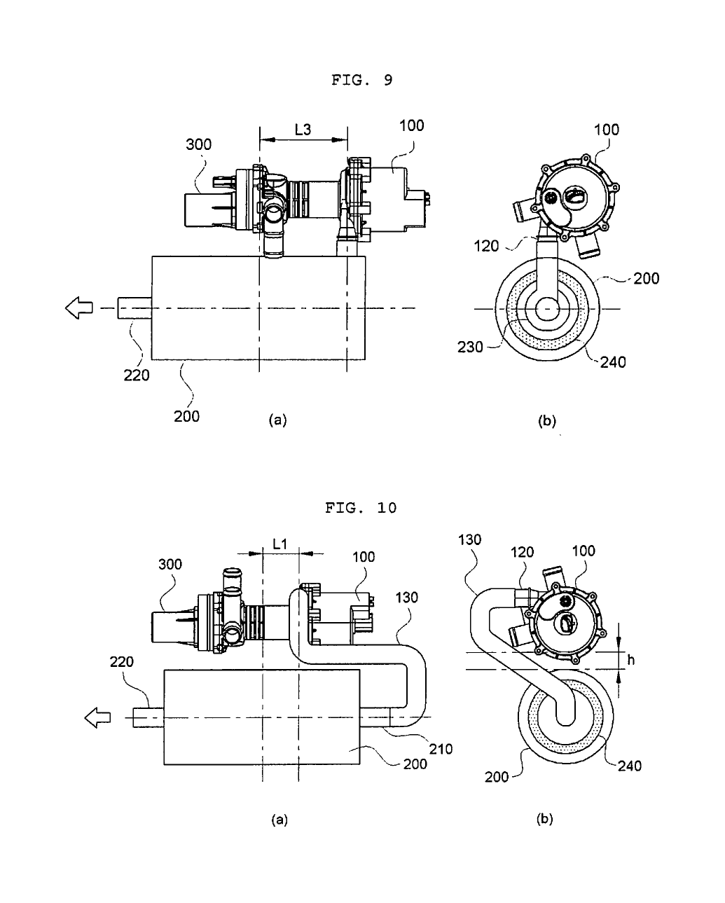

FIG. 9 shows a first modification example of a heater module for heating cooling water according to another embodiment of the present disclosure. In this case, the heater inlet 210 of the cooling water heating heater 200 may be formed to an outer circumferential surface of the cooling water heating heater 200 with a cylindrical shape, and the cooling water heating flow channel 230 may be formed with a helical shape. In this case, the cooling water discharged through the pump outlet 120 may be introduced to the cooling water heating heater 200 to further prevent interruption of a flow of the cooling water.

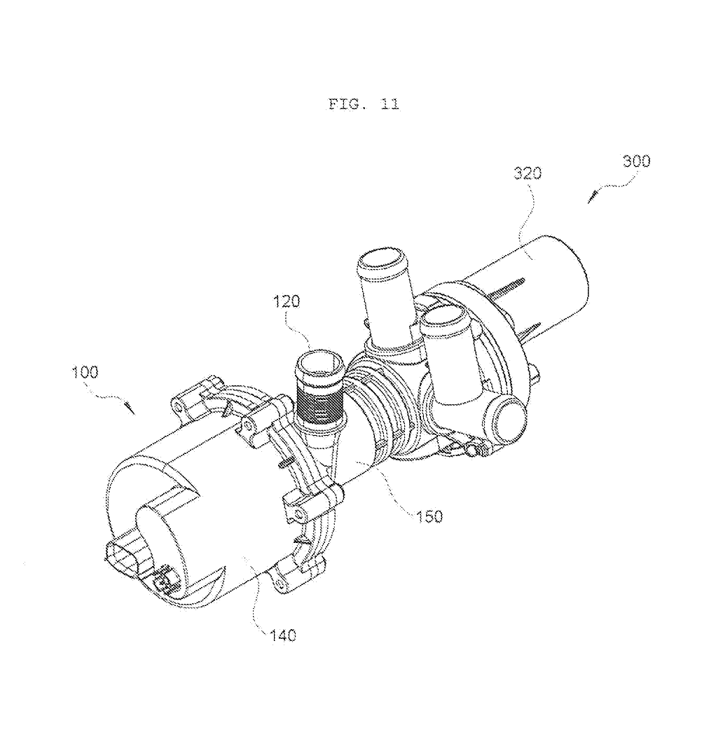

FIG. 10 shows a second modification example of a heater module for heating cooling water according to another embodiment of the present disclosure. In this case, the pump outlet 120 of the fluid pump 100 and a heater inlet of the cooling water heating heater 200 may be directly connected to each other without a separate connection hole. In this case, both the center of a fluid inlet of the fluid pump 100 and a heater inlet of the cooling water heating heater 200 may be spaced apart from the geometric center of the cooling water heating heater 200 by a predetermined distance L3, and an outlet of the fluid pump 100 may be disposed downward in a third direction that is orthogonal to the first direction and the second direction. In this case, a separate connection hole is not required, and thus, the number of components may be reduced, and a module may be configured to be more compact.

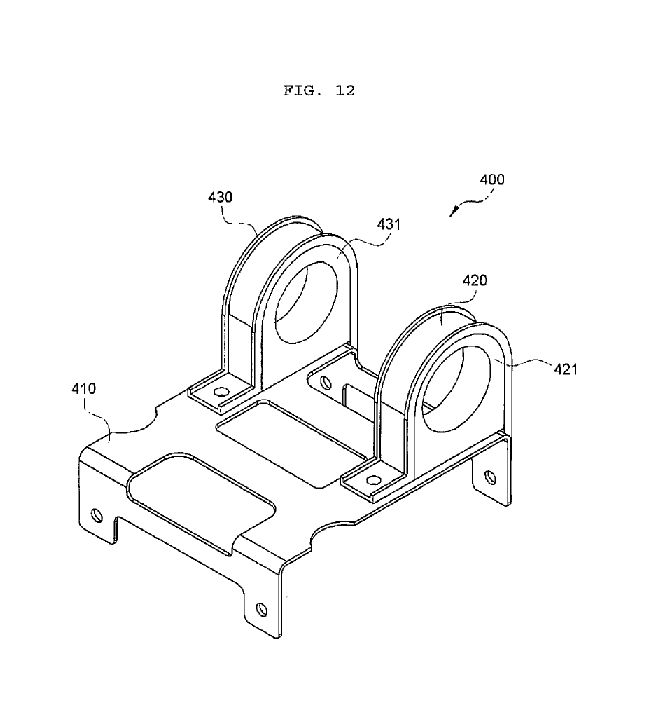

FIG. 11 is a diagram showing the case in which the fluid pump 100 and the flow channel switch valve 300 are integrally formed according to an embodiment of the present disclosure and, here, a valve pump connection hole 150 may be formed in such a way that the valve outlet 310 of the flow channel switch valve 300 and the pump inlet 110 of the fluid pump 100 are directly connected to each other without a separate connection hose. In this case, the valve outlet 310 and the pump inlet 110 may be directly connected to each other via hook coupling, screw coupling, or the like or may be integrally injected and formed without a separate coupling structure.

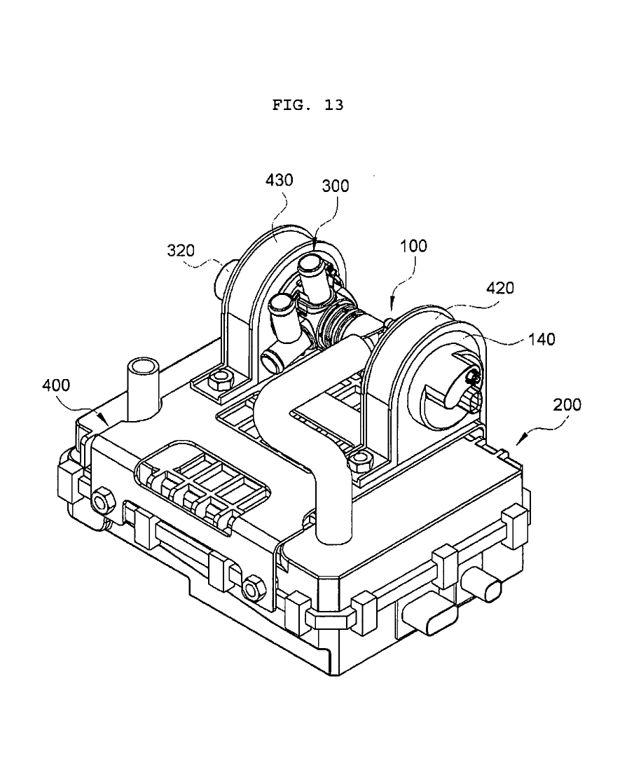

FIGS. 12 and 13 are diagrams for explanation of the case in which the fluid pump 100, a flow channel switch valve, and the cooling water heating heater 200 are integrally formed using a bracket 400 according to an embodiment. Referring to FIG. 12, the bracket 400 according to an embodiment of the present disclosure may include a base bracket 410 coupled to the cooling water heating heater 200, a fluid pump fix bracket 420 for coupling the fluid pump 100, and a flow channel switch valve fix bracket 430 for coupling the flow channel switch valve 300. In this case, the fluid pump fix bracket 420 may be formed to surround an outer circumference of the pump operation unit 140 of the fluid pump 100, and the flow channel switch valve fix bracket 430 may be formed to surround an outer circumference of the valve operation unit 320 of the flow channel switch valve 300, thereby accommodating a reaction during an operation of the fluid pump 100 and the flow channel switch valve 300. Although the drawing illustrates the case in which the fluid pump fix bracket 420 and the flow channel switch valve fix bracket 430 are coupled to the base bracket 410 via bolt coupling or the like, another equivalent coupling method may be applied, and as necessary, the fluid pump fix bracket 420 and the flow channel switch valve fix bracket 430 may be integrally injected and formed with the base bracket 410 without a separate coupling structure.

In order to absorb vibration during an operation of the fluid pump 100 and the flow channel switch valve 300, a fluid pump fix vibration absorber 421 may be disposed between the fluid pump fix bracket 420 and the fluid pump 100, and a flow channel switch valve fix vibration absorber 431 may be disposed between the flow channel switch valve fix bracket 430 and the flow channel switch valve 300. Although FIG. 12 illustrates the case in which the fluid pump fix vibration absorber 421 and the flow channel switch valve fix vibration absorber 431 are configured as separate components, as necessary, the fluid pump fix bracket 420 and the fluid pump fix vibration absorber 421 may be configure as one component, and the flow channel switch valve fix bracket 430 and the flow channel switch valve fix vibration absorber 431 may be configure as one component.

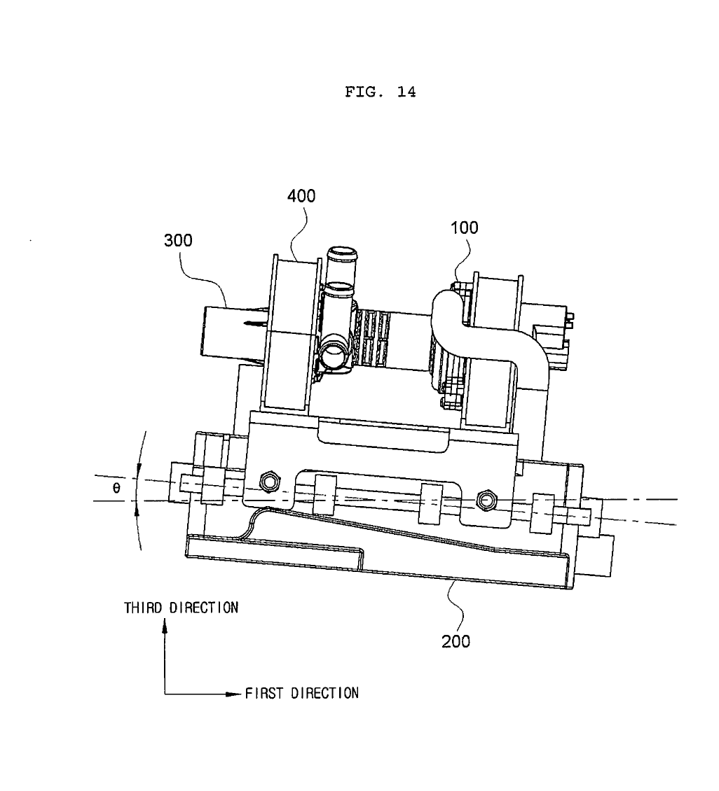

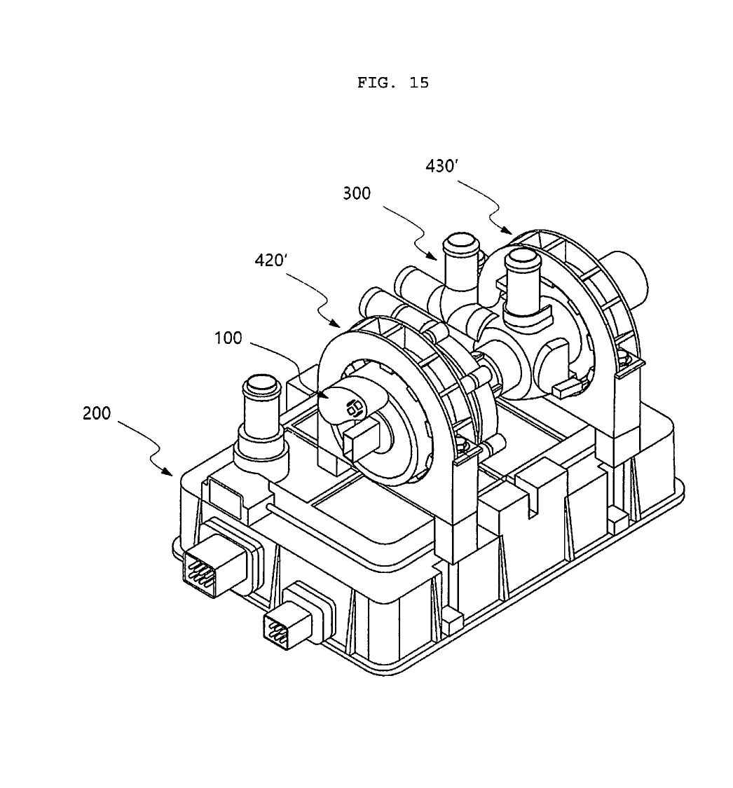

As described above, the heater module for heating cooling water according to the present disclosure may be advantageous in that the fluid pump 100 and the flow channel switch valve 300 are integrally formed with the cooling water heating heater 200 to be simply installed in a vehicle body. As shown in FIG. 14, the heater module for heating cooling water according to the present disclosure may be coupled to the vehicle body to be inclined to lower a side of the fluid pump 100 by a predetermined angle θ based on a horizontal surface when being coupled to the vehicle body, thereby reducing a cavitation phenomenon during an operation of the fluid pump 100.

FIGS. 15 to 18 show the case in which a fluid pump fix bracket 420′ and a flow channel switch valve fix bracket 430′ are coupled directly to cooling water heating heater according to another embodiment of the present disclosure.

Referring to FIG. 15, the heater module for heating cooling water according to another embodiment of the present disclosure may be configured in such a way that the fluid pump 100 and the flow channel switch valve 300 are integrally coupled and disposed above the cooling water heating heater 200, and the fluid pump fix bracket 420′ and the flow channel switch valve fix bracket 430′ couple the fluid pump 100 and the flow channel switch valve 300 to an upper portion of the cooling water heating heater 200, respectively.

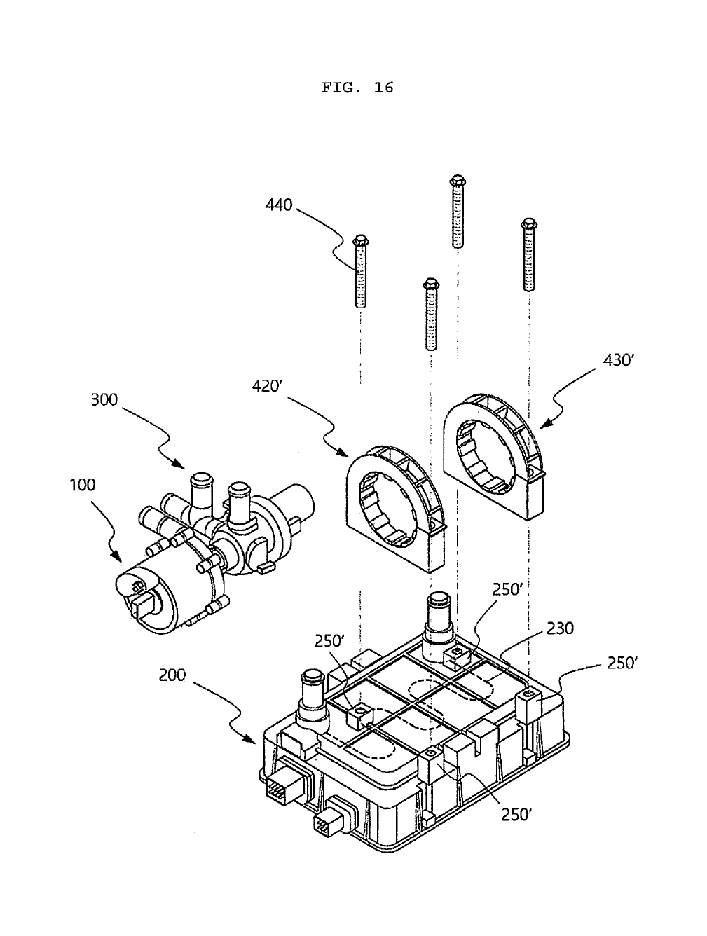

FIG. 16 is an exploded perspective view of a heater module for heating cooling water according to another embodiment of the present disclosure. A bracket coupler 250′ with a bolt hole formed therein may be formed to couple the fluid pump fix bracket 420′ and the flow channel switch valve fix bracket 430′ to the upper portion of the cooling water heating heater 200. In this case, the bracket coupler 250′ may protrude to dispose the fluid pump 100 and the flow channel switch valve 300 to be spaced apart from an upper surface of the cooling water heating heater 200 by a predetermined interval and, thus, heat and vibration of the cooling water heating heater 200 may not be transferred directly to the fluid pump 100 and the flow channel switch valve 300, and vibration of the fluid pump 100 and the flow channel switch valve 300 may not be transferred to the cooling water heating heater 200.

Through holes with coupling bolts 440 inserted thereinto may be formed in opposite sides of each of the fluid pump fix bracket 420′ and the flow channel switch valve fix bracket 430′, and the coupling bolts 440 may penetrate the through holes of each of the fluid pump fix bracket 420′ and the flow channel switch valve fix bracket 430′ and may be coupled to the bracket coupler 250′ and, thus, the fluid pump 100 and the flow channel switch valve 300 may be coupled to the cooling water heating heater 200 to be prepared as one module.

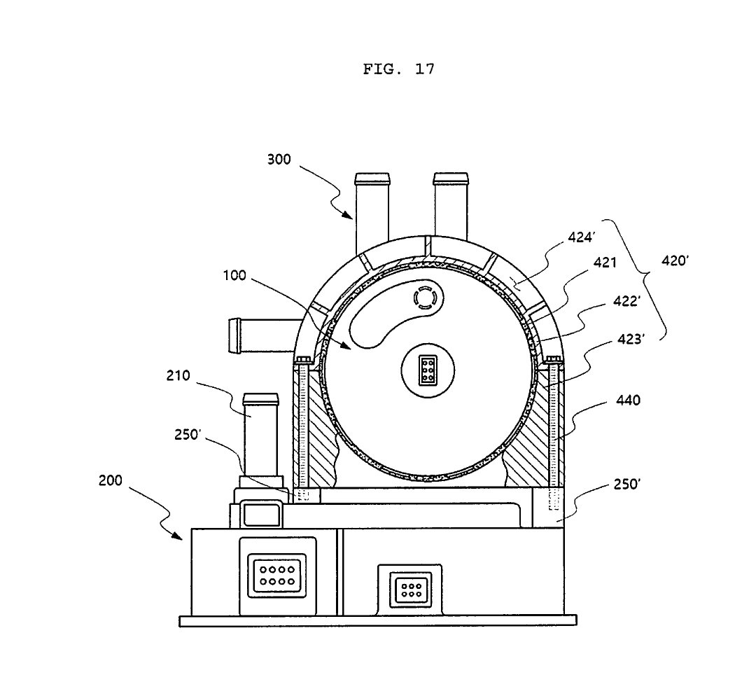

FIG. 17 is a front view of a heater module for heating cooling water according to another embodiment of the present disclosure. Referring to FIG. 17, the fluid pump fix bracket 420′ may include a fluid pump upper-portion fix bracket 422′, a fluid pump lower-portion fix bracket 423′, and the fluid pump fix vibration absorber 421, and a groove 424′ may be formed on the remaining portion of an external surface of the fluid pump upper-portion fix bracket 422′ except for a portion that contacts the fluid pump 100 to reduce the weight and, instead, a plurality of reinforcing ribs may be formed around the groove 424′ to reinforce stiffness. As described above, the coupling bolts 440 may penetrate the fluid pump upper-portion fix bracket 422′ and the fluid pump lower-portion fix bracket 423′ and may be coupled to the bracket coupler 250′ formed on the upper surface of the cooling water heating heater 200 and, thus, the fluid pump 100 and the flow channel switch valve 300 may form a module integrated into the cooling water heating heater 200.

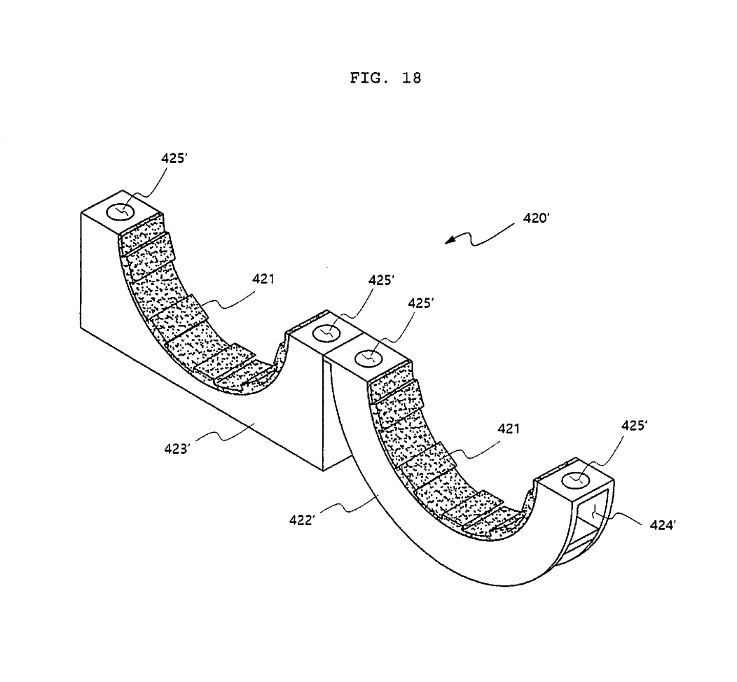

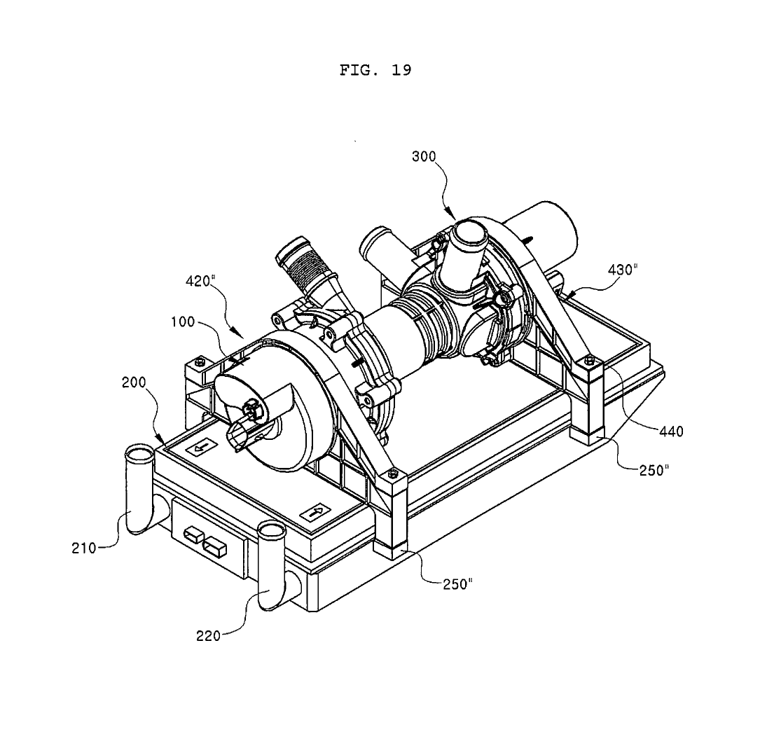

FIG. 18 illustrates disassembled upper and lower portions of the fluid pump fix bracket 420′. Through holes 425′ with the coupling bolts 440 penetrating therethrough may be formed at opposite ends of the fluid pump upper-portion fix bracket 422′, and the fluid pump fix vibration absorber 421 may be disposed on an internal surface of the fluid pump upper-portion fix bracket 422′. As described above, the groove 424′ may be formed on the remaining portion of the external surface of the fluid pump upper-portion fix bracket 422′ except for the portion that contacts the fluid pump 100 to reduce the weight. The through holes 425′ penetrating the coupling bolts 440 may also be formed at opposite ends of the fluid pump lower-portion fix bracket 423′, and the fluid pump fix vibration absorber 421 may be disposed on an internal surface of the fluid pump lower-portion fix bracket 423′. For example, the fluid pump fix bracket 420′ may be configured in the form of handcuffs with separated upper and lower portions and may be configured in such a way that the fluid pump 100 is disposed above the fluid pump lower-portion fix bracket 423′ and the fluid pump upper-portion fix bracket 422′ is rotated to accommodate the fluid pump 100. The fluid pump fix vibration absorber 421 may be formed of a rubber material and may be disposed between the fluid pump upper-portion fix bracket 422′ and the fluid pump 100, and between the fluid pump lower-portion fix bracket 423′ and the fluid pump 100 to attenuate vibration and noise that occur during an operation of the fluid pump 100 and to vibration and noise that occur during an operation of the fluid pump 100 from being transferred to the cooling water heating heater 200. In a procedure of molding the fluid pump upper-portion fix bracket 422′ and the fluid pump lower-portion fix bracket 423′, the fluid pump fix vibration absorber 421 may be molded therewith using a method via double-shot injection. Although not shown in FIGS. 17 and 18, the flow channel switch valve fix bracket 430′ may also be formed with the same structure as the fluid pump fix bracket 420′.

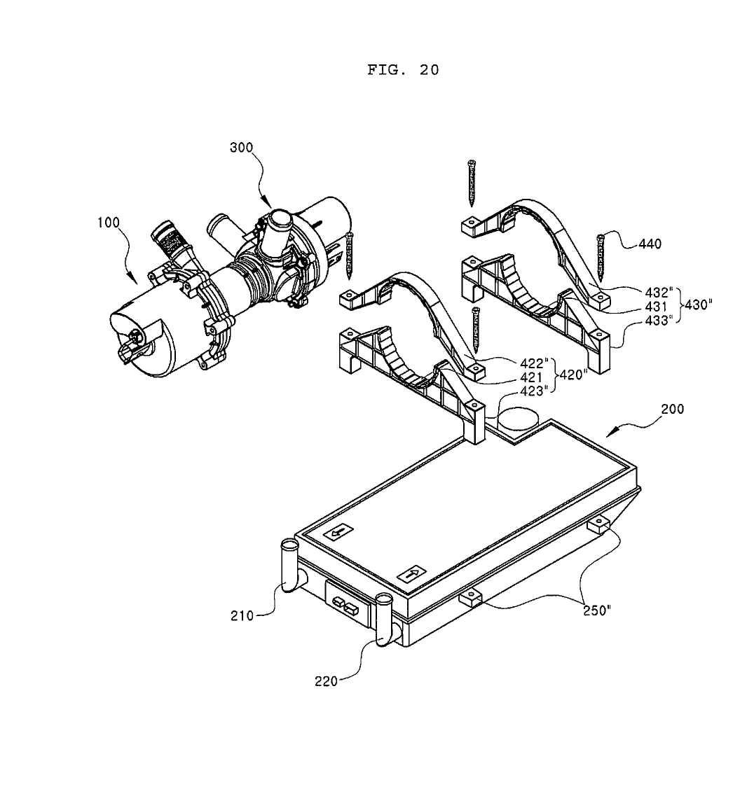

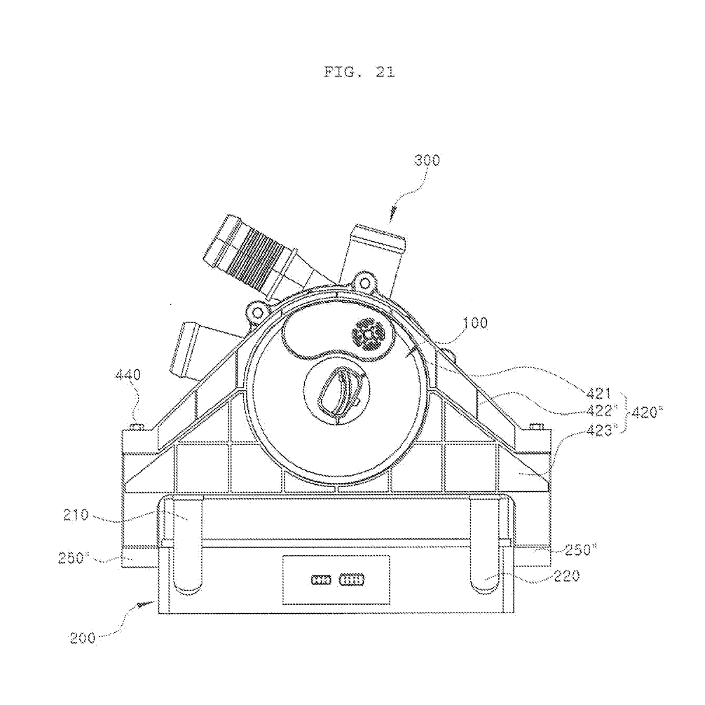

FIGS. 19 and 20 show the case in which the fluid pump fix bracket 420′ and the flow channel switch valve fix bracket 430′ are coupled directly to a case of cooling water heating heater according to another embodiment of the present disclosure. Referring to FIGS. 19 and 20, a bracket coupler 250″ may protrude from a side surface of a housing of the cooling water heating heater 200, the fluid pump fix bracket 420′ and the flow channel switch valve fix bracket 430′ may each be coupled onto the bracket coupler 250″ that protrudes from the side surface, and the fluid pump 100 and the flow channel switch valve 300 may be coupled to the cooling water heating heater 200 to form one module. In this case, the heater inlet 210 for introducing cooling water to the cooling water heating heater 200 and the heater outlet 220 for discharging the cooling water may be disposed on the same side surface, and in detail, the heater inlet 210 and the heater outlet 220 may be disposed on a side surface close to a side of the fluid pump 100, thereby reducing a cavitation phenomenon.

FIG. 21 is a front view of a heater module for heating cooling water according to another embodiment of the present disclosure. Referring to FIG. 21, a fluid pump fix bracket 420″ may include a fluid pump upper-portion fix bracket 422″, a fluid pump lower-portion fix bracket 423″, and the fluid pump fix vibration absorber 421, and a plurality of reinforcing ribs may be formed on the fluid pump upper-portion fix bracket 422″ and the fluid pump lower-portion fix bracket 423″ to reinforce stiffness. As described above, the bracket coupler 250″ may protrude from the side surface of the housing of the cooling water heating heater 200, and the fluid pump fix bracket 420″ may be fixed onto the bracket coupler 250″ that protrudes from the side surface. In detail, one bracket coupler 250″ for fixing the fluid pump 100 may protrude from each of opposite side surfaces of the cooling water heating heater 200, and one bracket coupler 250″ for fixing the flow channel switch valve 300 may also protrude from each of the opposite side surfaces of the cooling water heating heater 200.

The coupling bolts 440 may penetrate the fluid pump upper-portion fix bracket 422″ and the fluid pump lower-portion fix bracket 423″ and may be coupled to the bracket coupler 250″ that protrudes from the side surface of the cooling water heating heater 200 and, thus, the fluid pump 100 and the flow channel switch valve 300 may be integrally formed with the cooling water heating heater 200 to form one module. In this case, the fluid pump lower-portion fix bracket 423″ may be formed to be spaced apart from upper and side surfaces of the cooling water heating heater 200 by a predetermined interval to prevent heat of the cooling water heating heater 200 from being transferred directly to the fluid pump 100 and to prevent vibration of the fluid pump 100 from being transferred to the cooling water heating heater 200. Although not shown in FIG. 21, a flow channel switch valve fix bracket 430″ may also be formed with the same structure as the fluid pump fix bracket 420″.

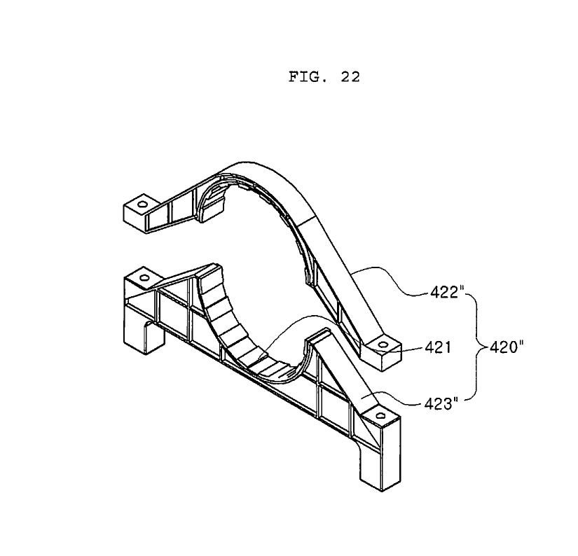

FIG. 22 illustrates disassembled upper and lower portions of the fluid pump fix bracket 420″ according to another embodiment. Through holes with the coupling bolts 440 penetrating therethrough may be formed at opposite ends of the fluid pump upper-portion fix bracket 422″ and the fluid pump fix vibration absorber 421 may be disposed on an internal surface of the fluid pump upper-portion fix bracket 422″, through holes with the coupling bolts 440 penetrating therethrough may also be formed at opposite ends of the fluid pump lower-portion fix bracket 423″ and the fluid pump fix vibration absorber 421 may be disposed on an internal surface of the fluid pump lower-portion fix bracket 423″. As described above, the fluid pump fix vibration absorber 421 may attenuate vibration and noise that occur during an operation of the fluid pump 100 and may prevent vibration and noise that occur during an operation of the fluid pump 100 from being transferred to the cooling water heating heater 200. In a procedure of molding the fluid pump upper-portion fix bracket 422″ and the fluid pump lower-portion fix bracket 423″, the fluid pump fix vibration absorber 421 may be molded therewith using a method via double-shot injection. The flow channel switch valve fix bracket 430′ may also include the flow channel switch valve fix vibration absorber 431, a flow channel switch valve upper-portion fix bracket 432″, and a flow channel switch valve lower-portion fix bracket 433″ in the same form as the fluid pump fix bracket 420′.

According to the present disclosure, the cooling water heating heater, a pump for pressurizing a circulated cooling water, and a valve for switching a flow channel may be integrally modularized to embody both a heating mode and a battery temperature-rising mode by one heater module for heating cooling water and, thus, a connection hose for connection components may be removed or a length thereof may be minimized, and a fluid pump and a valve housing may be reduced, thereby reducing costs and reduce the number of assembly processes.

A fluid pump may be disposed to be inclined to cooling water heating heater and to prevent interruption of pressurization and supply of cooling water, thereby enhancing circulation efficiency.

A structure for preventing overheating and vibration of a fluid pump may be proposed to form an integrated module and to reduce a malfunction.

In addition, a fluid pump may be disposed to be inclined and may be mounted to be inclined downward while being installed in a vehicle and, thus, a cavitation phenomenon may be reduced when cooling water is pressurized.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

1. A heater module for heating cooling water comprising:
a fluid pump including a pump inlet configured to introduce cooling water thereinto and a pump outlet configured to pressurize and discharge the introduced cooling water; and
cooling water heating heater including a heater inlet configured to introduce thereinto the cooling water discharged from the pump outlet of the fluid pump, a heating unit configured to heat the introduced cooling water, and a heater outlet configured to discharge the heated cooling water,
wherein the fluid pump is integrally formed with one side of the cooling water heating heater.

2. The heater module of claim 1, wherein:
the fluid pump is disposed to be inclined to one side at a geometric center of the cooling water heating heater; and
the heater inlet of the cooling water heating heater is formed close to the fluid pump disposed to be inclined to the one side, and the heater outlet of the cooling water heating heater is formed far from the fluid pump disposed to be inclined to the one side.

3. The heater module of claim 2, wherein:
the pump outlet of the fluid pump is disposed perpendicular to a direction in which the cooling water of the pump inlet is introduced; and
an outlet of the pump outlet is disposed toward the heater inlet.

4. The heater module of claim 3, wherein:
the cooling water heating heater includes a heating body for heating the cooling water, and cooling water heating flow channel for guiding a flow of the cooling water; and
the cooling water heating flow channel is formed to be disposed in parallel to a direction of an opening of the pump outlet.

5. The heater module of claim 4, wherein:
the heating body of the cooling water heating heater is a planar heating body; and
the cooling water heating flow channel is formed in a zigzag form above the planar heating body.

6. The heater module of claim 3, wherein:
the pump outlet is disposed downward in a direction toward the cooling water heating heater;
the heater inlet is formed to face an end of the pump outlet; and
the pump outlet and the heater inlet are directly coupled to each other.

7. The heater module of claim 1, further comprising:
a flow channel switch valve for switching a flow channel of the cooling water,
wherein the flow channel switch valve is positioned at one side of the fluid pump and is integrally formed with the cooling water heating heater.

8. The heater module of claim 7, wherein:
the flow channel switch valve includes a plurality of openings; and
one of the plurality of openings is formed to be integrally coupled to the pump inlet of the fluid pump.

9. The heater module of claim 8, wherein:
the flow channel switch valve and the fluid pump are integrally formed and are disposed to be inclined to one side of the cooling water heating heater; and
the heater inlet of the cooling water heating heater is formed closer to the fluid pump than the flow channel switch valve.

10. The heater module of claim 7, further comprising:
a bracket for integrally coupling the fluid pump and the fluid channel switch valve to the cooling water heating heater.

11. The heater module of claim 10, wherein:
a fluid pump fix vibration absorber configured to absorb vibration during an operation of the fluid pump is inserted between the fluid pump fix bracket and the fluid pump; and
a flow channel switch valve fix vibration absorber configured to absorb vibration during an operation of the flow channel switch valve is inserted between the flow channel switch valve fix bracket and the flow channel switch valve.

12. The heater module of claim 11, wherein:
a plurality of bracket couplers with the fluid pump fix bracket and the flow channel switch valve fix bracket coupled thereto are formed above the cooling water heating heater; and
the bracket coupler protrudes upward to dispose the fluid pump and the flow channel switch valve to be spaced apart from an upper surface of the cooling water heating heater.

13. The heater module of claim 12, wherein:
the fluid pump fix bracket and the flow channel switch valve fix bracket are configured in the form of handcuffs with separated upper and lower portions, the upper and lower portions having one rotatable side; and
the fluid pump or the flow channel switch valve is accommodated between the upper and lower portions.

14. The heater module of claim 11, wherein:
a plurality of bracket couplers with the fluid pump fix bracket and the flow channel switch valve fix bracket coupled thereto protrude in a lateral direction on a side surface of the cooling water heating heater; and
the fluid pump fix bracket and the flow channel switch valve fix bracket are coupled to an upper surface of the bracket coupler.

15. The heater module of claim 14, wherein;
the fluid pump fix bracket and the flow channel switch valve fix bracket are each separated to an upper bracket and a lower bracket; and
the lower bracket is formed to be spaced from the side surface and the upper surface of the cooling water heating heater by a predetermined interval.

16. The heater module of claim 11, wherein:
the bracket further includes a base bracket coupled to the cooling water heating heater; and
the fluid pump fix bracket and the flow channel switch valve fix bracket are formed to be coupled to the base bracket.

17. The heater module of claim 3, wherein the cooling water heating heater is formed in a cylindrical shape and includes a cylindrical heating body for heating the cooling water therein.

18. The heater module of claim 17, wherein:
the cooling water heating heater includes cooling water heating flow channel disposed with a helical shape; and
the heater inlet of the cooling water heating heater is formed in an outer circumferential surface of the cooling water heating heater,
wherein the pump outlet of the fluid pump is disposed downward in a direction toward the cooling water heating heater; and
the heater inlet is directly coupled to and faces an end of the pump outlet.

19. A vehicle mounted with the heater module for heating cooling water of claim 1.

20. The vehicle of claim 19, wherein the heater module is mounted to be inclined to lower a side of the fluid pump by a predetermined angle based on a horizontal surface.
